(19) United States
(12) Patent Application Publication
(10) Pub. No.: US 2024/0316511 A1
(43) Pub. Date: Sep. 26, 2024

(54) Hub With Interchangeable Arms for A Mixer And Interchangeable Mixing System

(71) Applicant: FLACKTEK SPEEDMIXER, INC., LANDRUM, SC (US)

(72) Inventors: Matthew L. GROSS, Boulder, CO (US); Jeff HANSEN, Loveland, CO (US); Max GULDEN, Boulder, CO (US); Dale FLACKETT, Landrum, SC (US)

(21) Appl. No.: 18/577,780

(22) PCT Filed: Jul. 8, 2022
(86) PCT No.: PCT/US22/36509

§ 371 Date: Jan. 9, 2024

Related U.S. Application Data
(60) Provisional application No. 63/220,258, filed on Jul. 9, 2021.

(51) Int. Cl. B01F 29/10; B01F 29/20; B01F 35/32

(52) U.S. Cl. CPC B01F 29/10; B01F 29/20; B01F 35/3204; B01F 35/3215

(57) ABSTRACT

The invention described herein includes an interchangeable mixing system having a universal hub configured to rotate along an approximately vertical X axis. The universal hub of the invention may further include opposing flanges for individually mounting and removing one or more mixing cup limbs adapted to secure a mixing cup. A mixing drive can be adapted to rotate the mixing cup limb, and preferably counter-rotate the cup limbs along an asymmetrical axis (Y). In preferred embodiments, the mixing drive can be adapted to rotate the universal hub and one or more mixing cup limb through a belt-drive assembly.

### CROSS-REFERENCE TO RELATED APPLICATIONS

This International PCT application claims the benefit of and priority to U.S. Provisional Application No. 63/220,258 filed Jul. 9, 2021, the specification, claims and drawings of which are incorporated herein by reference in their entirety.

### TECHNICAL FIELD

The present disclosure relates generally to devices, systems, and methods of mixing. More specifically, the present disclosure relates to devices, systems, and methods of centrifugal mixing using a hub with interchangeable arms.

### BACKGROUND OF THE INVENTION

It can be desirable to mix a variety of materials components such as, but not limited to, creams, liquids, viscous polymers or powders at various scales. Conventional dual-action centrifugation “DAC” mixing arms present challenges in adapting a mixer to different sized batches or scales. The rotational arm and central rotation point are typically machined as a single unit and therefore must be swapped out for an entirely different rotational unit to perform different mixing profiles. Challenges arise in swapping the entire unit, as they are extremely heavy and bulky, as well as costly to machine making the possibility of damage to the rotational unit unacceptably high. Likewise maintenance is difficult in that the entire unit might need to be removed for access to work on or to perform maintenance on the unit.

### SUMMARY OF INVENTION

One aspect of the invention includes an interchangeable mixing system. According to one preferred aspect, an interchangeable mixing system of the invention may include a universal hub comprising opposing flanges for individually mounting and removing one or more mixing cup limbs. The one or more mixing cup limbs can be configured to receive a mixing cup and to couple interchangeably the opposing flanges.

In additional aspects, the interchangeable mixing system of the invention can further include a mixing drive coupled to at least one mixing cup limb to rotate the mixing cup. In certain embodiment, a mixing cup of the invention comprises a separate or integral basket sleeve that may further include a drive adaptor having a recess and/or a plurality of teeth adapted to be responsive to a secondary drive shaft powered by a belt-drive assembly as described below.

One aspect of the invention includes an asymmetric interchangeable mixing system comprising a mixing arm. The mixing arm of the invention may include in a preferred embodiment, a universal hub, and one or more mixing cup limbs adapted to receive a mixing cup and individually mount to, or be removed from the universal hub. These one or more mixing cup limbs may include a receiver adapted to receive a mixing cup or counter-weight as described herein.

The asymmetric interchangeable mixing system of the invention may further include a universal hub having one or more opposing flanges for individually mounting and removing the one or more mixing cup limbs. In this preferred embodiment, the one or more mixing cup limbs comprise a pair of securing members forming a slot that receives the flange of the universal hub. The securing members and opposing flanges each include aligned openings adapted to receive a fastener so as to secure the mixing cup limbs the universal hub.

The asymmetric interchangeable mixing system of the invention may further include a universal hub having opposing angled surfaces that may be configured to allow the mixing cup limbs to be position relative to a second axis of rotation (Y) being offset and angled from the first axis of rotation (X) of the hub. In still further embodiments, the universal hub of the invention may in a central bore adapted to receive said drive shaft. The asymmetric interchangeable mixing system of the invention may further include a mixing drive having a drive shaft coupled with the universal hub, wherein the mixing drive causes the universal hub to rotate around an first axis (X).

The asymmetric interchangeable mixing system of the invention may further include a belt-drive assembly (also referred to as a belt-drive) coupled to at least one mixing cup limb responsive to the drive shaft and adapted to rotate a mixing cup around an second axis (Y). In one preferred embodiment, a belt-drive assembly of the invention comprises a motor coupled to each of the one or more mixing cup limbs so that each mixing cup limb is configured to provide rotation to the mixing cup independent of a second of the one or more mixing cup limbs.

In one preferred embodiment, the invention may include one, or a plurality of a belt-drive assemblies, each of which includes one or more motors, a belt responsive to said motor(s), and a gear responsive to the belt and a secondary drive shaft adapted to rotate a mixing cup along a second axis. In certain preferred embodiments, the belt comprises an O-ring belt, or a toothed serpentine belt, and may further be responsive to a toothed gear and the like. As noted above, a secondary drive shaft of the invention may be adapted to engage a drive adapter of a mixing cup.

In still further embodiment, a belt-drive assembly of the invention may include a motor coupled to a pair, or more, of mixing cup limbs so that each mixing cup limb is configured to provide synchronous rotation to the mixing cups.

The asymmetric interchangeable mixing system of the invention may further include a belt-drive assembly configured to provide synchronous rotation to the mixing cups. In this preferred embodiment, a belt-drive assembly of the invention includes a belt, such as an O-ring belt, or a toothed serpentine belt, which is responsive to the drive shaft of a mixing-drive. In one preferred embodiment, an adaptor disk may be positioned so as to be responsive to the belt and drive shaft to facilitate the transfer of rotational energy of the shaft to drive movement of the belt. The belt of the invention can be coupled with a one, or a plurality of rollers to facilitate the movement of the belt, and may further be responsive to a rotational disk, such as a gear, or even a toothed gear, which is coupled with a secondary drive shaft adapted to rotate a mixing cup around a second axis (Y). In a preferred embodiment, a secondary drive shaft is adapted to engage a drive adapter of a mixing cup.

The mixing system of the invention may further include a vacuum system that may be continuously engaged during operation of the mixing system, and preferably DAC mixing. In a preferred embodiment, a vacuum system of the invention may include a vacuum chamber coupled to the one or more mixing cup limbs. (Such elements may be integral, or separable.) A vacuum path may further be formed between the vacuum chamber and a vacuum source, such as a vacuum pump responsive to a controller, and one or more vacuum lines coupled to the universal hub. The vacuum chamber(s) of the invention may be coupled with a vacuum line through a port, such coupling be detachable so as to facilitate removal and replacement of the mixing arms as described herein. As further described herein, the vacuum system of the invention may in include embodiment wherein the vacuum path passes through the drive shaft, being coupled with a rotary coupling connecting allowing the vacuum path to retains its integrity while also allowing rotation of the drive shaft and corresponding hub, which may include a universal hub as described herein, or a traditional hub as used in DAC mixing applications.

### BRIEF DESCRIPTION OF THE DRAWINGS

The drawings disclose exemplary embodiments m which like reference characters designate the same or similar parts throughout the figures of which:

FIG. 1. Illustrates interchangeable mixing system showing the system includes a hub, one or more mixing cup limbs, and a mixing drive system in one embodiment thereof;

FIG. 1A is a plan view of an universal hub that can be used in the interchangeable mixing system of FIG. 1 in one embodiment thereof;

FIG. 1B is a plan view of an exemplary mixing cup limb that can be coupled to the universal hub and used in the interchangeable mixing system of FIG. 1 in one embodiment thereof;

FIG. 1C illustrates a mixing basket that can be coupled to a mixing cup limb and used in the interchangeable mixing system of FIG. 1 in one embodiment thereof;

FIG. 2 illustrates a mixing drive of the interchangeable mixing system of FIG. 1 in showing each mixing cup limb is equipped with its own motor to rotate independent of each other and of the universal hub in one embodiment thereof;

FIG. 3 illustrates a mixing drive of the interchangeable mixing system of FIG. 1 showing an O-ring interconnecting the universal hub and each mixing cup limb so that rotation of each of the hub and each mixing cup limb is dependent on the mixing drive system in one embodiment thereof;

FIG. 4 illustrates a mixing drive of the interchangeable mixing system of FIG. 1 showing an serpentine timing-style belt interconnecting the universal hub and each mixing cup limb so that rotation of each of the hub and each mixing cup limb is dependent on the mixing drive system in one embodiment thereof; and

FIG. 5 illustrates a sectional view vacuum system of the interchangeable mixing system in a dual asymmetrical mixing device 100 of FIG. 1, allowing a vacuum to be exerted on a mixing cup on each mixing cup limb during rotation of each mixing cup limb in one embodiment thereof.

### DETAILED DESCRIPTION OF THE INVENTION

Unless otherwise indicated, the drawings are intended to be read (for example, crosshatching, arrangement of parts, proportion, degree, or the like) together with the specification, and are to be considered a portion of the entire written description of this invention. As used in the following description, the terms “horizontal”. “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of the surface relative to its axis of elongation, or axis of rotation, as appropriate.

Traditional rotational mixers are made of a single solid machined arm to which mixing cups can be attached. This structure is heavy, and requires additional machining, materials, maintenance, and installation efforts given its structure. In particular, the entire arm unit must be removed, for example, and swapped out during manufacturing with another different entire arm unit from a rotation drive system in order to mix significantly different batch sizes.

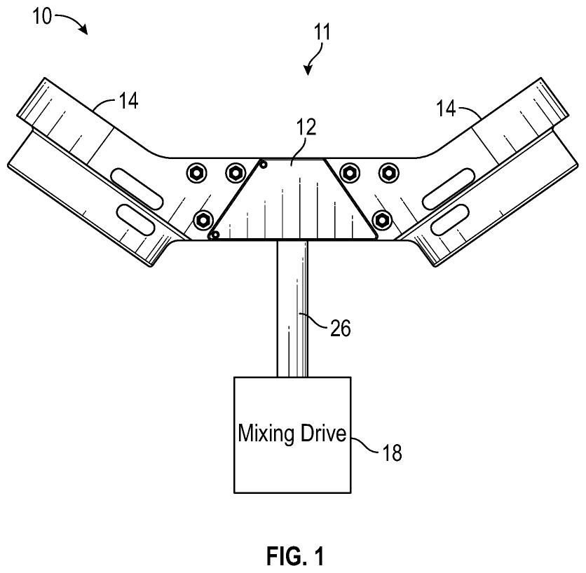

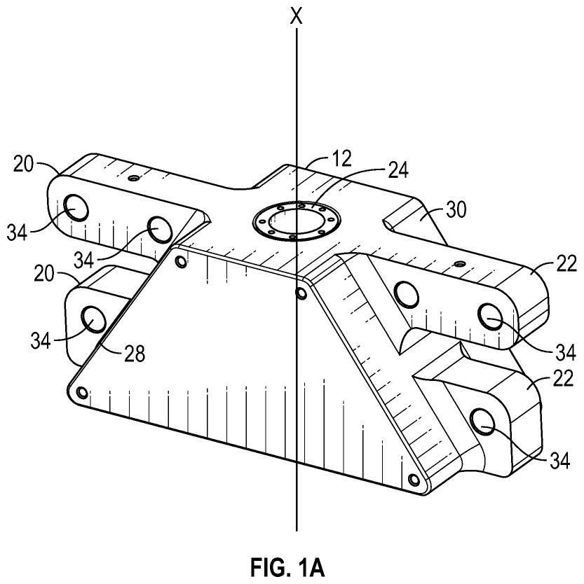

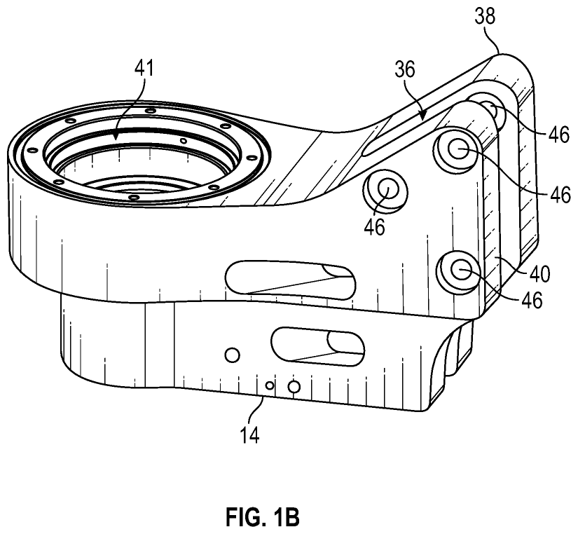

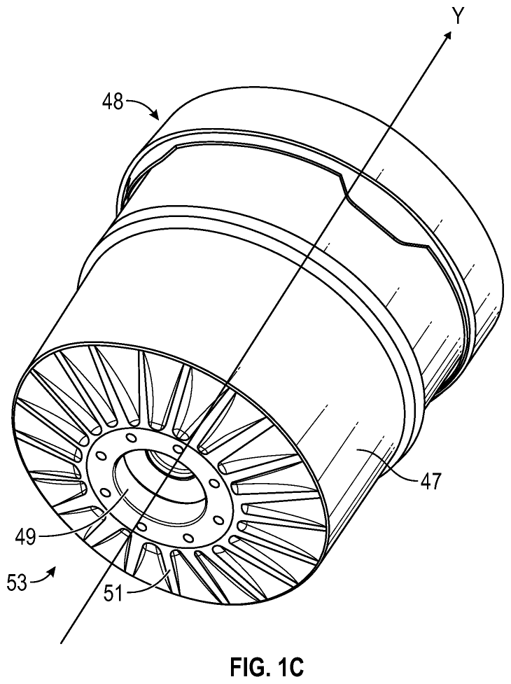

Referring to FIG. 1, an exemplary embodiment of an interchangeable mixing system 10 is shown with a mixing arm 11 including universal hub 12, mixing cup limbs 14, 16 coupled to the hub 12, and a mixing drive system 18 for driving rotation of the universal hub 12 with the mixing cup limbs 14, 16 about a hub rotation axis (X). The mixing drive system can include a mixing drive 18 comprising any of any of a gearbox, direct drive, belt driven motor, chain drive, or any other suitable drive mechanism coupled to a driveshaft 26.

As seen in FIG. 1A, the universal hub 12 includes two flanges 20, 22 formed that extend in opposite directions from the hub rotation axis (X), and can include a central bore 24 for receiving a driveshaft 26, which can also have a central bore for adding/removing liquids and/or gases, of the mixing drive 18. Flanges 20, 22, can each extend out from angled surfaces 28, 30 to provide attachment ports for mixing cup limbs 14, 16 and can include openings 34 to couple to and release the mixing cup limbs 14, 16 by fasteners such as bolts, or other couplers, such as quick release couplers and the like. The universal hub 12 can be used to attach a mixing limb composed of metal basket receiver for holding a container, while the other side of the central hub can be used as an active or passive counter weight as described further with respect to FIG. 1B.

As illustrated in FIG. 1B, an exemplary mixing cup limb 14, can include a slot 36 formed as a recess between a securing member, which in this embodiment is shown as two parallel projecting securing members 38, 40, sized to receive either of flanges 20, 22 so that corresponding angled surfaces 42, 44 of each securing member 38, 40 contacts angled surface 28 of the universal hub 12 when the mixing cup limb is coupled to the universal hub 12. Securing members 38, 40 can each include a plurality of aligned openings 46 configured to align with flange openings 34, to receive the fasteners or other couplers. Receiver 41, may be formed to couple to a plurality of different sized mixing cups, or a counterweight. Although FIG. 1B is described with respect to mixing cup limb 14, the same features and functions are ascribed to mixing cup limb 16.

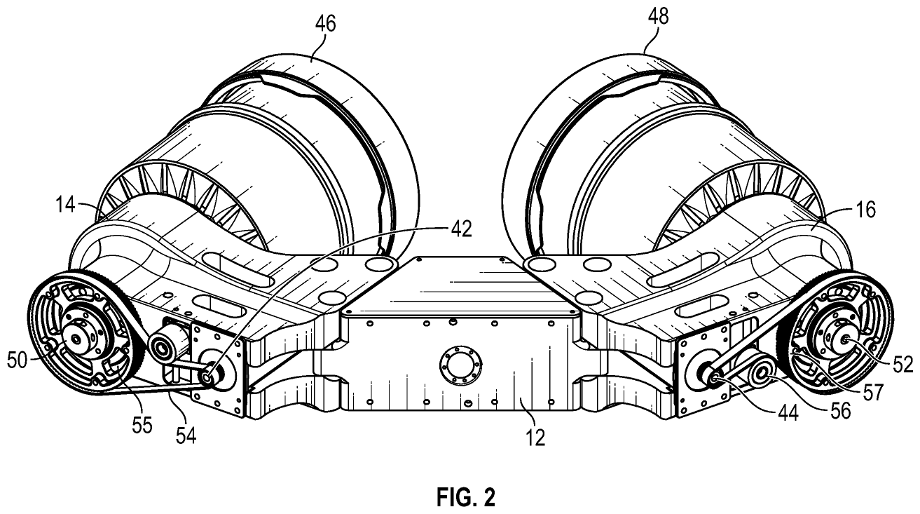

FIG. 1C shows a mixing cup 48, that includes a mixing basket/sleeve 47 with a driver adapter 53 including a bottom recess 49 and teeth 51 radially extending from the bottom recess and projecting outwardly from the bottom surface of the sleeve, which are adapted to engage with a driveshaft 26 or components or assembly responsive to a driveshaft 26, as discussed further with respect to FIGS. 2-4, to rotate, or preferably rotate the mixing cup 48 along a Y-axis and thereby form a DAC system. Although this drive adapter is illustrated as a sleeve for coupling to the mixing cup 46, it is possible that the adapter could be formed as part of the mixing cup itself.

FIG. 2, illustrates a mixing drive in which the mixing drive, and preferably a belt-drive assembly may include a mixing drive for each mixing cup limb 14, 16, each including a respective motor 42, 44 for driving a rotation of each mixing cup 46, 48, about a respective cup rotation axis (Y) formed at secondary driveshafts 50, 52. In this manner, the rotation speed of each mixing cup 46, 48, can be individually controlled to rotate at different speeds. As illustrated in FIG. 2, the motors can provide the rotation through drive belts, 54, 56 which may be toothed serpentine belts, that each loop around a respective motor 42, 44 and mixing cup gear 55, 57. Gears 55, 57 can be coupled to secondary driveshafts 50, 52 to rotate each respective mixing cup 46, 48. This embodiment may be incorporated with the mixing drive of FIG. 1 to further provide additional independent rotation of the universal hub 12 and arms 14, 16.

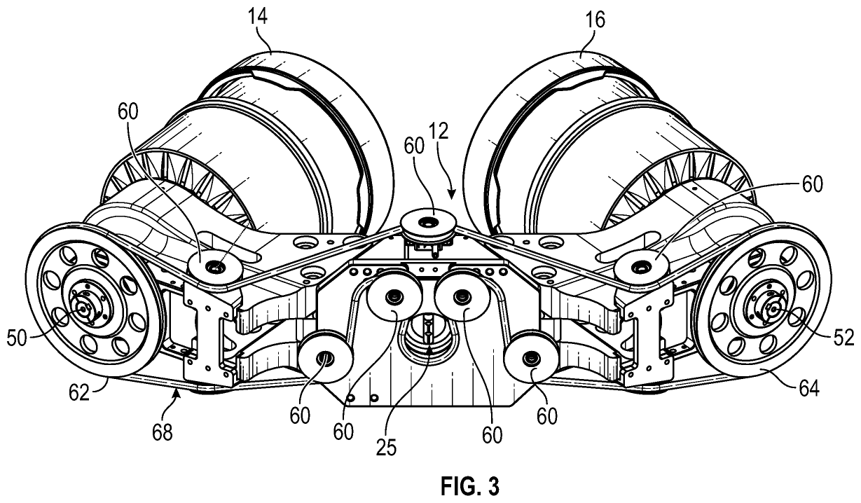

According to FIG. 3, a mixing drive may be provided in which a looped O-ring 68 drives rotation of both mixing cups 14, 16 at the same rate. In this embodiment, an adaptor disk 25 may be provided around the driveshaft 26 of FIG. 1, so that rotation of the driveshaft 26 that rotates the universal hub 12 also drives the O-ring 68, which is fitted to run around a plurality of rollers 60 and drive rotation disks 62, 64, to rotate both mixing cups 14, 16. Therefore, the same mixing drive system 18 can be used to provide rotation about the hub axis (X) and the respective cup rotation axes (Y) at secondary driveshafts 50, 52.

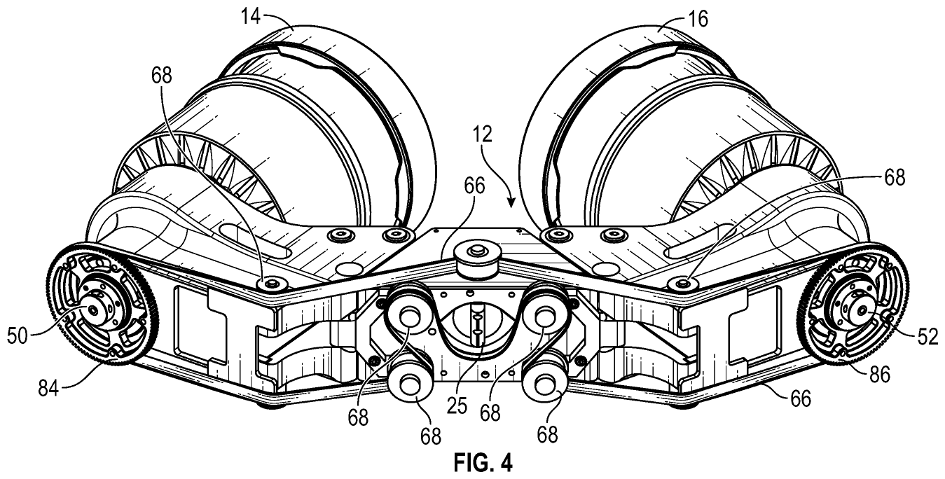

As seen in FIG. 4, a mixing drive may be provided in with a serpentine belt 66 drives rotation of both mixing cups 14, 16 at the same rate. In this embodiment, an adaptor disk 25 may be provided around the driveshaft 26 of FIG. 1, so that the rotation of the driveshaft 26 that rotates the universal hub 12 also drives the serpentine belt, which may be toothed, and which is fitted to run around a plurality of rollers 68 and drive toothed gears 84,86 to rotate both mixing cups 14, 16 via their secondary drive shafts 50, 52. Therefore, the same mixing drive system 18 can be used to provide rotation about the hub axis (X) and the respective cup rotation axes (Y) at secondary drive shafts 50, 52.

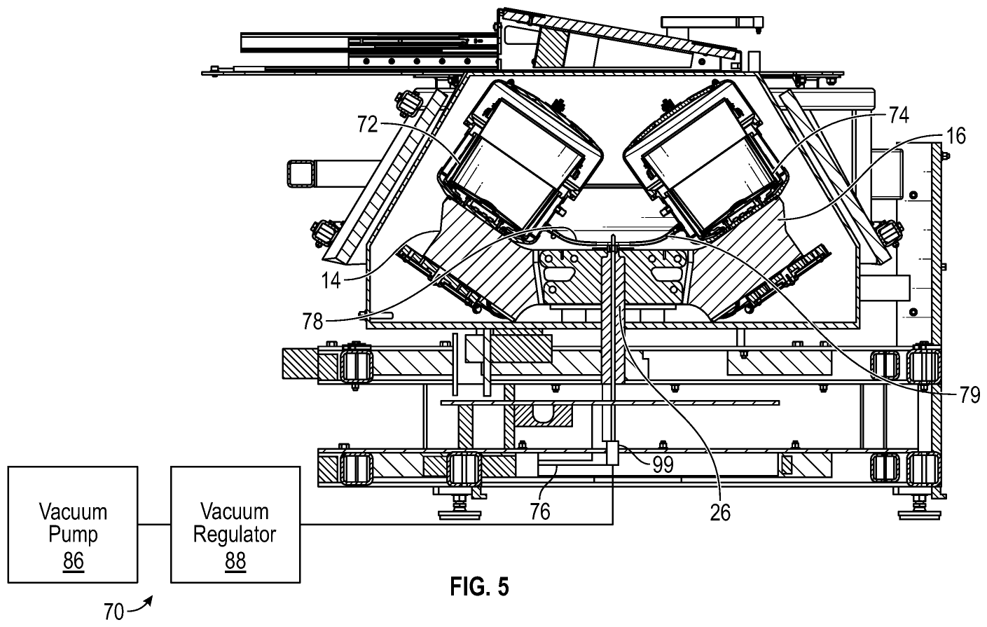

FIG. 5 illustrates an interchangeable mixing system 10 that further incorporates a vacuum system 70. The vacuum system can include one or more vacuum chambers 72, 74, coupled to each mixing cup limb 14, 16. The vacuum chambers 72, 74, are mounted to each mixing cup limb, for example, at each receiver 41 of mixing cup limb 14, 16, are in fluid communication with a stationary vacuum source, such as a vacuum pump 86 including a vacuum regulator 88 to control the vacuum. As illustrated a vacuum line 76 forms a path between the vacuum pump 86 and the vacuum chambers 72, 74, extending through the drive shaft 26 and entering one side of the universal hub and exiting the opposite side. The vacuum line 76 splits into two lines 78, 79 to attach to a port 80, 81 of each vacuum chamber 72, 74 to exert vacuum pressure on each mixing cup 46, 48 inside the respective vacuum chamber. The stationary vacuum source 86 or pump may be positioned external to the interchangeable mixing system 10 so that as the interchangeable mixing system 10 rotates according to any of the above described mechanisms, a vacuum can be applied to each vacuum chamber 72, 74. Although this embodiment is illustrated with a single vacuum line 76, there could also be a separate vacuum line and regulator coupled to each vacuum chamber 72, 74 allowing for different vacuum conditions in each vacuum chamber 72, 74. The vacuum system of the invention may in include embodiment wherein the vacuum path passes through the drive shaft, being coupled with a rotary coupling 90 connecting allowing the vacuum path to retains its integrity while also allowing rotation of the drive shaft and corresponding hub, which may include a universal hub as described herein, or a traditional hub as used in DAC mixing applications.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims. For example, the same universal hub can be used for manufacturing various different sizes and iterations of similar systems with different limb sizes/formations. While the methods, equipment and systems have been described in connection with specific embodiments, it is not intended that the scope be limited to the particular embodiments set forth, as the embodiments herein are intended in all respects to be exemplary rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

Disclosed are components that can be used to perform the disclosed methods, equipment and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods. Any patents, applications and publications referred to herein are incorporated by reference in their entirety.

1. An asymmetric interchangeable mixing system comprising:
a mixing arm comprising:
a universal hub;
one or more mixing cup limbs adapted to receive a mixing cup and individually mount to, or be removed from said universal hub;
a mixing drive having a drive shaft coupled with said universal hub, wherein said mixing drive causes said universal hub to rotate around a first axis; and
a belt-drive assembly coupled to at least one mixing cup limb responsive to said drive shaft and adapted to rotate a mixing cup around a second axis.

2. The system of claim 1, wherein said universal hub comprises opposing flanges for individually mounting and removing the one or more mixing cup limbs.

3. The system of claim 2, wherein the one or more mixing cup limbs comprise a pair of securing members forming a slot that receives the flange of said universal hub.

4. The system of claim 3, wherein said securing members and said opposing flanges each include aligned openings adapted to receive a fastener.

5. The system of claim 1, wherein said universal hub comprises opposing angled surfaces.

6. The system of claim 1, wherein said universal hub comprises a central bore adapted to receive said drive shaft.

7. The system of claim 1, wherein the one or more mixing cup limbs comprises a receiver adapted to receive a mixing cup or counter-weight.

8. The system of claim 1, wherein said mixing cup comprises a basket sleeve.

9. The system of claim 8, wherein said basket sleeve comprises a drive adapter.

10. The system of claim 9, wherein said drive adapter comprises a recess or a plurality of teeth adapted to be responsive to a secondary drive shaft.

11. The system of claim 1, wherein said belt-drive assembly comprises a motor coupled to each of the one or more mixing cup limbs so that each mixing cup limb is configured to provide rotation to the mixing cup independent of a second of the one or more mixing cup limbs.

12. The system of claim 11, wherein said belt-drive assembly comprises:
a motor;
a belt responsive to said motor; and
a gear responsive to said belt and a secondary drive shaft adapted to rotate a mixing cup along a second axis.

13-15. (canceled)

16. The system of claim 1, wherein said belt-drive assembly comprises a motor coupled to a pair of mixing cup limbs so that each mixing cup limb is configured to provide synchronous rotation to the mixing cups.

17. The system of claim 16, wherein said belt-drive assembly comprises:
a belt responsive to said drive shaft;
a plurality of rollers; and
a rotational disk responsive to said belt and a secondary drive shaft adapted to rotate a mixing cup around a second axis.

18. The system of claim 17, further comprising an adaptor disk responsive to said belt and said drive shaft.

19-21. (canceled)

22. The system of claim 17, wherein said secondary drive shaft is adapted to engage a drive adapter.

23. The system of claim 1, wherein said belt-drive assembly comprises:
a belt responsive to said drive shaft;
a plurality of rollers; and
a rotational disk responsive to said belt and a secondary drive shaft adapted to rotate a mixing cup around a second axis.

24. The system of claim 23, further comprising an adaptor disk responsive to said belt and said drive shaft.

25-34. (canceled)

35. An interchangeable mixing system comprising:
a mixing arm comprising a universal hub having opposing flanges adapted to individually mount and remove one or more mixing cup limbs;
a mixing drive having a drive shaft coupled with said universal hub, wherein said mixing drive causes said universal hub to rotate around a first axis; and
wherein said one or more mixing cup limbs comprises a receiver adapted to receive a mixing cup or counter-weight.

36. The system of claim 35, further comprising a belt-drive assembly coupled to at least one mixing cup limb responsive to said drive shaft and adapted to rotate a mixing cup around a second axis.

37-93. (canceled)
